(19) United States
(12) Patent Application Publication
(10) Pub. No.: US 2007/0263284 A1
(43) Pub. Date: Nov. 15, 2007

(54) Telescope laser collimator accessory

(76) Inventor: Charles Howard Glatter, Bronx, NY (US)

Correspondence Address: Howard Glatter, Apt. 14F, 3850 Sedgwick Ave., Bronx, NY, 10463, US

(21) Appl. No.: 11/800,641

(22) Filed: May 7, 2007

Related U.S. Application Data
(60) Provisional application No. 60/798,664, filed on May 9, 2006.

(51) Int. Cl. G02B 23/00

(52) U.S. Cl. 359/423

(57) ABSTRACT

An accessory device used together with a telescope laser collimator to align the primary mirrors of Newtonian telescopes and single mirror prime focus telescopes. An internal lens diverges the laser collimator beam and projects it upon the primary mirror collimation mark. A shadow of the mark is projected back to the screen on the device, and the mirror is aligned by adjusting it to center the shadow on the device screen.

### RELATED APPLICATIONS

This application claims the benefit, under U.S.C. section 119, of U.S. Provisional Patent Application Ser. No. 60/798,664, Filed Apr. 9, 2006, entitled “Telescope collimation device.”

### FIELD OF INVENTION

The present invention relates to alignment of optical elements in telescopes and more particularly to an apparatus used in conjunction with a conventional laser telescope collimator to facilitate rapid and accurate angular alignment of the primary mirrors in Newtonian telescopes and in single mirror on-axis prime focus telescopes.

### BACKGROUND OF THE INVENTION

Critically accurate collimation of telescope optical elements is necessary to achieve maximum image contrast and resolution, particularly in the case of low focal-ratio astronomical instruments used at high image magnifications. Various methods and devices are known in the prior art and have been used to collimate the optical elements within telescopes.

Laser telescope collimators, for example as disclosed in the article “AstroBeam Laser Collimator” on pages 42 to 44 of the February 1996 issue of Astronomy magazine, represent a significant advance in telescope alignment technology. Although quite useful, laser telescope collimators have certain disadvantages which can allow significant inaccuracy in collimating telescope optical elements. For example, when used to collimate a Newtonian telescope, any small error in the angular alignment of the secondary mirror will result in a larger compounded error in the angular alignment of the primary mirror when the primary is adjusted to fold the laser beam back on itself.

This weakness has been largely eliminated by another advance in the art, disclosed in the article “Collimation with a Barlowed laser” by Nils Olof Carlin, published on pages 121 to 124 of the January 2003 issue of Sky and Telescope magazine. The Barlowed laser technique eliminates compounding of secondary mirror misalignment error when adjusting primary mirror alignment, and it is also relatively insensitive to alignment errors of the laser collimator within the eyepiece holder.

While Barlowed laser collimation of primary mirrors has several advantages over standard laser collimation, the combined collimating apparatus of the laser collimator and conventional telescope Barlow lens presents a long, bulky, and somewhat heavy burden to the usual telescope eyepiece holder or focuser drawtube that the combination must be mounted in. This disadvantage was overcome with this author's innovation of the self-Barlowed laser collimator, disclosed in an item entitled “Critical Collimation”, published in the New Product Showcase section, page 108, of the September 2004 issue of Sky and Telescope magazine. Although the self-Barlowed laser collimator significantly eases application of the Barlowed laser collimation technique, it shares a difficulty of conventional Barlowed laser collimation. In use, the Barlowed laser's target screen is often positioned deep within the focuser drawtube or eyepiece holder where it is difficult for the operator to see.

The present invention is directed toward overcoming one or more of the difficulties discussed above.

### SUMMARY OF THE INVENTION

The present invention provides an apparatus that attaches to the inner end of the eyepiece holder, focuser drawtube, or camera holder of a telescope and, in conjunction with a conventional laser collimator, facilitates critical collimation of the primary mirror by means of the Barlowed laser alignment technique. The subject apparatus includes means for securely attaching the body of the apparatus to the drawtube or other telescope feature aligned with the eyepiece axis.

The subject apparatus contains an axial hole extending through its body that aligns with the eyepiece axis of the telescope when the device is attached to the focuser drawtube. This hole contains a refractive lens or other transmissive optical element within it that diverges the collimated beam from a laser collimator mounted in the eyepiece or camera position of the drawtube, and projects the diverging beam towards the mirrors.

The surface of the subject device's body that faces the mirrors serves as a screen upon which the shadow of the primary mirror collimation target is projected by the reflected light beam returning from the mirrors. For Newtonian telescope collimation this surface is preferably angled with respect to the drawtube axis. An advantage of the present invention is that the angled screen surface is eminently visible to the operator throughout the primary mirror alignment procedure.

With a Newtonian telescope, another advantage of the present invention is that when the angled screen surface of the device is turned to face towards the primary mirror, the result of manipulating the primary mirror adjusters can, in most cases, be seen by the operator from the back of the telescope where the mirror adjusters are located, eliminating the need to walk back and forth to see the result of each adjustment iteration. In situations where the angled screen surface can not be seen from the back of a Newtonian telescope, for example, with a solid tube where there is no open space between the edge of the primary mirror and the telescope tube, the angled face of the subject device may be turned towards the front of the telescope where it is easily and closely observed by looking into the front of the telescope tube.

### BRIEF DESCRIPTION OF THE DRAWINGS

FIG. 1 is a cross sectional view of a preferred embodiment of the subject device, illustrating its essential features.

FIG. 2 is a cross sectional side view of a Newtonian telescope, with the subject Barlowed collimation device and a laser collimator installed in the telescope focuser's drawtube. The projected laser light, having been diverged by the lens in the subject device, has its marginal rays shown by arrowheads proceeding toward the secondary mirror, and thence toward the primary mirror. The collimated laser light reflected from the primary mirror has its marginal rays shown by arrowheads proceeding toward the secondary mirror, and thence toward the screen surface of the subject device.

### DETAILED DESCRIPTION OF THE INVENTION

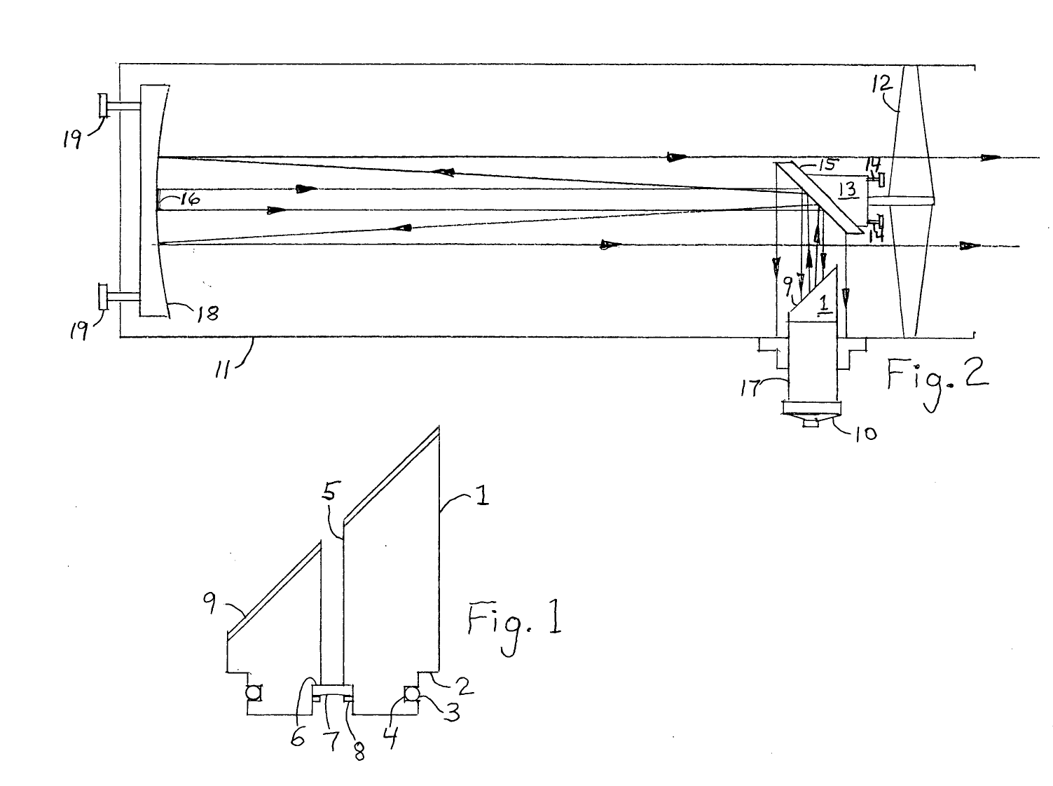

FIG. 1 represents a cross sectional view of a preferred embodiment of the present invention. The body 1 of the device is made of a durable, rigid, opaque material such as a dark colored acetyl or Nylon plastic, although it also may be made of metal or any other material that fulfills the aforementioned requirements. The body is preferably, although not necessarily made cylindrical in form, and of somewhat greater diameter than the inside diameter of the focuser drawtube or eyepiece holder that the device is intended to attach to. The end of the body that faces the laser collimator is made square with the body's cylindrical axis. A short length of this end is made slightly smaller in diameter than the inside diameter of the focuser drawtube into which it is intended to fit. This reduced diameter portion ends at a shoulder 2, which is made square with the cylindrical axis of the body. In use, the device is inserted into the focuser drawtube so that the shoulder contacts the end of the drawtube, insuring that the device's optical axis is aligned with the drawtube axis.

In a preferred embodiment, a resilient rubber or plastic o-ring 3 is installed in groove 4, formed on the reduced diameter portion of the device. The groove depth and o-ring thickness are chosen so that compression of the o-ring will provide secure retention when the device is inserted in the open end of the drawtube. Although this preferred embodiment utilizes an o-ring for centering and retention within the focuser drawtube, it is understood than many other means of centering and retention are possible, such as collet-like radially expanding segments formed on or attached to the end of the device body, or resilient plastic screws with broad, convex heads, threaded radially into the end of the device body. Such screws would be adjusted to make the device a push-fit into the end of the drawtube.

The device has an axial hole 5 extending completely through the body from one end to the other. In a preferred embodiment the hole 5 is counterbored at the reduced diameter end of the device to form a seat 6. A negative lens 7 of clear glass or plastic is placed against the seat in the counterbore and secured there by a retaining ring 8, preferably made of metal. The lens preferably has a focal length of approximately −50 mm. to insure that the beam from the laser collimator be diverged enough to extend beyond the edges of the collimation target on the primary mirror, yet not be so divergent that the reflected beam is too dim for easy visibility. Although in the preferred embodiment a negative lens is used to diverge the beam, any of several methods may be practiced to diverge the beam, such as using a diffractive optical element, or a pinhole, or using a positive lens that will cause the beam to diverge after passing through a focal point.

The end of the body which faces the telescope mirrors is preferably made flat, and at an angle close to 45 degrees with respect to the cylindrical body axis. Although the preferred embodiment has this face angled, it may also be square with the body cylindrical axis. This end of the body is preferably covered or coated with a light colored, matte finish material 9, such as flat white epoxy paint or self-adhesive matte white polyester film, so that it will serve as a diffusely reflective screen to enhance visibility of the projected collimation mark's shadow.

FIG. 2 schematically represents the subject invention being used in conjunction with a laser collimator 10 to align the primary mirror of a Newtonian telescope. 11 represents the telescope tube and 12 represents the secondary mirror spider. 13 is the secondary mirror mount and 14 are the secondary mirror adjusters. 15 is the secondary mirror. For the purpose of illustrating primary mirror collimation with the present device, it is assumed and represented that the secondary mirror has previously been aligned by manipulating the secondary mirror adjusters to center the laser beam upon the primary mirror collimation target 16, using the laser collimator alone in the drawtube 17. After secondary mirror alignment has been accomplished the subject device is inserted in drawtube as shown in FIG. 2.

The parallel rays of light from the laser collimator are converted to a diverging beam upon passage through the lens in the subject device, and are projected onwards to the secondary mirror. The diverging beam is reflected from the secondary mirror and projected towards the center of the primary mirror 18.

Upon reflection from the paraboloidal primary mirror, the diverging light beam is converted to a collimated beam with all parallel rays. To practice Barlowed laser collimation it is necessary to place a collimation target 16, which usually is a self-adhesive paper circle, triangle, or ring, upon the optical center of the primary mirror. The silhouette shadow of the collimation target will be contained within the collimated beam reflected from the primary mirror, and the position of the shadow within the beam represents the true location of the primary mirror's optical axis. In some telescopes the primary mirror has a central hole, so a collimation target can not be placed on the mirror. In these cases the hole itself will serve as the collimation target, and will produce a shadow within the beam reflected from the primary mirror.

The reflected beam proceeds towards the secondary mirror, and is reflected by the secondary to the face of the subject invention. The silhouette shadow of the primary mirror collimation target appears upon the subject device's screen, and the operator collimates the primary mirror by manipulating the primary mirror adjusters 19 to visually center the shadow upon the central hole aperture in the device's screen face.

Although in FIG. 2 the subject device is utilized for collimation of a Newtonian telescope primary mirror, the device can also be used in conjunction with a laser collimator to collimate the primary mirror of a single mirror on-axis prime focus telescope. These telescopes are almost universally used for imaging. In the case of such a telescope, the laser collimator and the subject apparatus are mounted in the camera holder of the telescope, in like fashion as they are mounted in the drawtube of a Newtonian telescope.

Although the preferred embodiment of the present invention has been described above, it should be understood that the present invention is not limited thereto, and that other modifications will be apparent to those skilled in the art without departing from the spirit of the invention.

I claim:

1. An apparatus used in conjunction with a telescope laser collimator to collimate the primary mirror of a Newtonian telescope or of a single mirror on-axis prime focus telescope, comprising:
a body containing means to removeably attach and retain the apparatus to the interior end of a telescope eyepiece holder or camera holder.
a hole through the body coincident with the eyepiece or camera optical axis.
an optical element attached to the body and mounted coincident with the hole to diverge the beam from the laser collimator.
A screen surface on the body to receive a shadow image from the telescope primary mirror collimation mark.

2. The apparatus of claim 1, wherein the attaching and retaining means is an o-ring seated in a groove in the body.

3. The apparatus of claim 1, wherein the attaching and retaining means is outwardly expanding body segments.

4. The apparatus of claim 1, wherein the attaching and retaining means is screws threaded into the device body.

5. The apparatus of claim 1, wherein the optical element is a lens.

6. The apparatus of claim 1, wherein the optical element is diffractive diffuser.

7. The apparatus of claim 1, wherein the optical element is a pin hole.
